(19) United States
(12) Patent Application Publication
(10) Pub. No.: US 2006/0150232 A1
(43) Pub. Date: Jul. 6, 2006

(54) Tap bypass assembly

(76) Inventor: George S. Karpati, Quakertown, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/027,228

(22) Filed: Dec. 30, 2004

(51) Int. Cl. H04N 7/173

(52) U.S. Cl. 725/127

(57) ABSTRACT

An inventive tap bypass with a notch in each stinger insert of each stinger connection member is disclosed. The present invention provides an inventive tap bypass for easy lateral installation into a tap assembly by use of notched stinger inserts which can pivot for horizontally or vertically displaced stingers.

### FIELD OF THE INVENTION

The present invention relates to signal propagation infrastructure. More specifically, the present invention relates to signal distribution tap assemblies (“taps” or “tap assembly(ies)”).

### BACKGROUND OF THE INVENTION

Today a complex series of signal lines are run either above or below ground to get signals carrying data to your home, business, or other premise (collectively referred to herein as “premise” or “premises”). Power (current) is also provided on the signals lines. These signals are typically radio frequency (“RF”) signals and, the power is typically an alternating current (“AC”). The signals propagate through a transmission/distribution infrastructure (“infrastructure”) and typically include the classic “triple play” (voice (telephony), video and Internet data). The use of a common infrastructure to transmit and distribute the above mentioned signals and power is the current industry philosophy for high bandwidth data transmission, distribution and delivery, with the AC current needed to supply power to line amplifier(s).

Many components and parts make up this infrastructure, such as the main signal lines, e.g., coaxial cables, fiberoptic cables, etc.; signal amplifiers, to account for attenuation of the signal as the signal travels great distances to reach its destination(s); and taps, which essentially function as signal splicers, off a main signal line, to provide connectivity to premises local to the taps, respectively.

Today, most infrastructures use a hybrid fiberoptic/coaxial cable system, where coaxial cable is often physically found closer to premises and fiberoptical cable is generally found in longer runs (between coaxial cable runs) because of the decreased attenuation characteristic of fiberoptic cable.

In areas where coaxial cable is used in the infrastructure, taps are used to provide connectivity of premises which are physically located near each tap, respectively. For example, if a main signal line (made of coaxial cable) of the infrastructure is hanging on poles going down a street, the coaxial cable would have at least one tap, for groups of 2, 4, 8, or more premises, where each tap interconnects a number of unique premises in that block with the main signal line.

Taps are a critical component in the above described conventional infrastructure. However, when a taps fails and needs to be repaired or replaced, premises interconnected to the tap, as well as premises downstream, enter a loss of service/signal state and loss of power (current). As used herein, “service/signal” includes the RF signal and the AC power collectively. Loss of service/signal is highly undesirable because of the presence of telephone service (voice) on the main signal line. Loss of telephone service can have drastic effects in the case of an emergency, where a telephone call requesting assistance needs to be placed.

Previously, when a tap needed to be repaired or replaced, the entire tap needed to be cut from the main signal line resulting in service/signal loss of approximately two (2) hours. To alleviate this extensive service/signal loss time, a tap bypass assembly (“tap bypass”) was developed. The tap bypass allows a tap to be repaired or upgraded without service/signal interruption to premises downstream. (As used herein the term “upstream” refers to the portion of a signal line on the side of a tap assembly closest to the service provider, e.g., cable head end, etc. Conversely, as used herein the term “downstream” refers to the portion of a signal line on the side of a tap assembly furthest from the service provider.) However, when the tap bypass needs to be replaced itself, the service/signal loss time is again approximately two (2) hours to replace the entire tap, or approximately 30 minutes to one (1) hours to replace the tap bypass, which is a meticulous process. (The tap bypass is also commonly known in the art as a “seizure assembly”.)

In addition to replacing tap bypasses due to failure or defect, service providers, such as cable companies, are also upgrading non-bypass taps (taps without tap bypasses) by installing tap bypasses. Conservatively, there are millions of non-bypass taps in service in North America alone. Thus, the service/signal loss time, during the installation of each tap bypass, needs to be substantially reduced.

Thus, what is needed is a tap bypass which can be installed with minimal service/signal downtime for premises downstream.

### SUMMARY OF INVENTION

An object of the present invention is to provide a tap bypass which can be installed with minimal service/signal downtime for premises downstream, and method of manufacturing the same.

In order to achieve this objective, as well as others which will become apparent in the disclosure below, the present invention provides for a tap bypass, where each stinger connection member comprises a notched stinger insert.

In an exemplary embodiment of the present invention, the tap bypass has two stinger connection members, each member having a notched stinger insert to receive a stinger of a main signal line with ease. Each stinger insert is communicatively and physically connected to stingers of an upstream and downstream main signal line, respectively. The present invention also provides a method of manufacture where each stinger connection member is fabricated during the manufacturing process to include the inventive notched stinger inserts and connection member housing to allow the notched stinger inserts, respectively, to pivot to laterally receive a stinger in a horizontal or vertical position.

The present invention, advantageously permits a service provider to install, for upgrade or replacement, the inventive tap bypass in a few minutes. The inventive tap bypass can be installed without removing the entire tap and only requires the (i) removal of the tap faceplate, (ii) unscrewing of a few tap bypass mounting screws and removal of the old tap bypass assembly by simply pulling it out (only if an old tap bypass was previously installed), (iii) easy insertion of the inventive tap bypass, which slides lateral on top of the stingers, and (iv) securing the inventive tap bypass with mounting screws. The above process utilizing the inventive tap bypass of the present invention only takes a few minutes.

Thus, the present invention provides a tap bypass which can be installed with minimal service/signal downtime for premises downstream, and method of manufacturing the same.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1(a) is an illustration of a front side of a typical tap assembly enclosure;

FIG. 1(b) is an illustration of a back side of a tap assembly enclosure;

FIG. 2(a) is an illustration a tap assembly with the front side cover removed and showing a first side “A” of a conventional tap bypass;

FIG. 2(b) is an illustration of the opposite side “B” of a conventional tap bypass, outside of a tap assembly enclosure;

FIG. 2(c) is an illustration of a close-up of a stinger connection member on the opposite side “B” of a conventional tap bypass;

FIG. 2(d) is an illustration of a tap assembly, with the front side cover and conventional tap bypass removed, showing the stingers;

FIG. 3(a) is an illustration of a side “B” of an inventive tap bypass in accordance with an exemplary embodiment of the present invention; and

FIG. 3(b) is an illustration of a close-up of a stinger connection member on side “B” of the inventive tap bypass in accordance with an exemplary embodiment of the present invention.

### DESCRIPTION OF A PRESENTLY PREFERRED EMBODIMENT

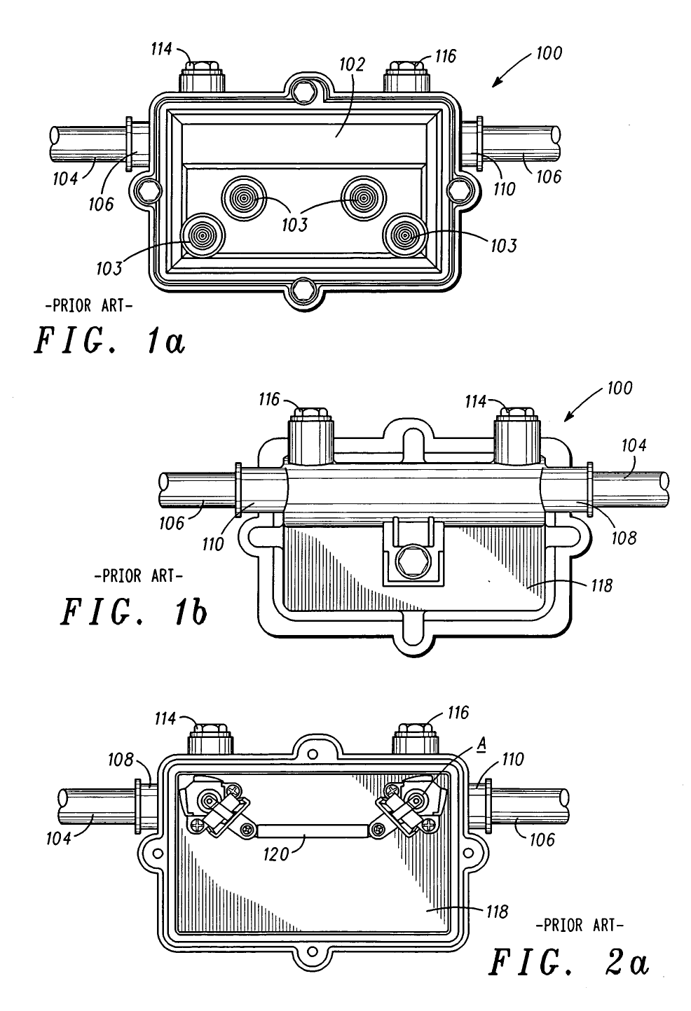

In order to fully understand the inventive tap bypass of the present invention, a description of a conventional tap bypass is provided herein. FIG. 1 (a) is an illustration of a front side cover 102 of a tap assembly 100. The connections 103 on front side cover 102 are for connectivity to premises located physically near tap assembly 100 to receive service/signal from main signal lines 104, 106. Main signal lines 104, 106 carry voice, video, Internet data, and AC power (current), as described above, and may be any type of signal line capable of carrying such data using RF, or any other type of carrier signal, and a power (current). Main signal lines 104, 106 may be a truck line, for example. The upstream main signal line 104 is physically and communicatively connected to tap assembly 100 at tap input 108. Similarly, the downstream_main signal line 106 is physically and communicatively connected to tap assembly 100 at tap output 110. Please note that upstream main signal line 104 and downstream_main signal line 106 are communicatively bilateral signal lines. The terms “upstream” and “downstream” in the phrases “upstream main signal line” and “downstream main signal line” are used herein simply for ease of reference. As can be seen in FIG. 1(a), tap assembly 100 essentially functions as a signal splicer to provide signal(s) to premises receiving the signal from outputs 103 on tap front cover 102. Tap assembly 100 also provides the signal downstream for use by other tap assemblies, where the other tap assemblies are affixed to the downstream signal line to provide signal to premises physically located downstream, respectively. Please note that in addition to horizontal input 108, tap assembly 100 has vertical input 114 to accommodate an upstream main signal line in either orientation, as the main signal line 104 meets tap assembly 100. A typically use of the vertical input 114 would be if tap assembly 100 is positioned at a corner, where downstream main signal line 106 is 90 degrees from upstream main signal line 104. Similarly, tap assembly 100 has a vertical output 116 for similar reasons. Referring to FIG. 1(b), FIG. 1(b) illustrates the a back side cover 118 of tap assembly 100.

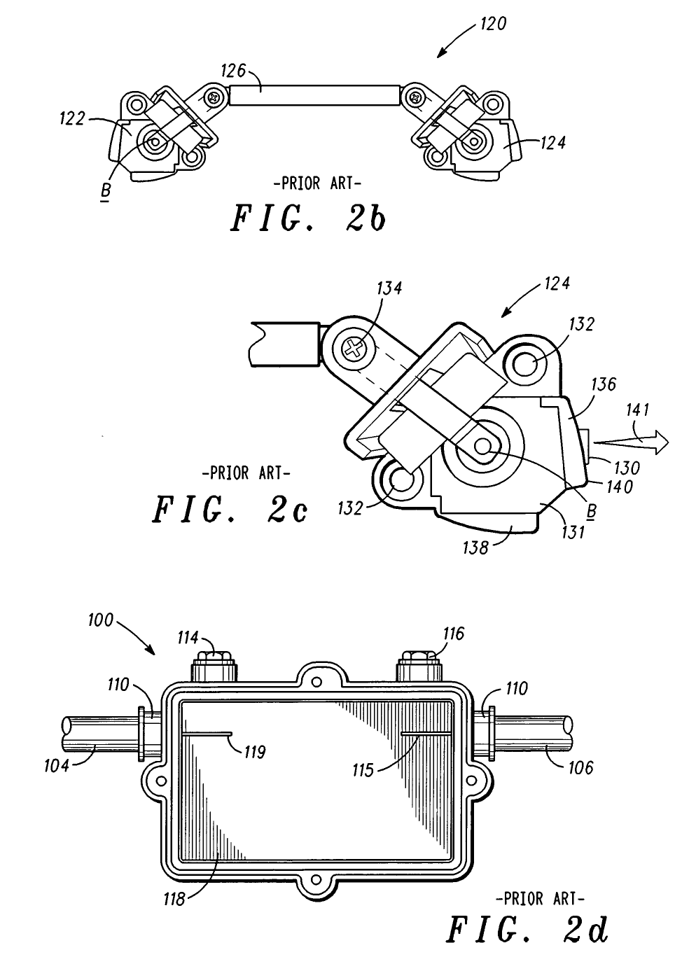

Referring to FIG. 2(a), FIG. 2(a) is an illustration of tap assembly 100 with front side cover 102 removed and showing one side “A” of a conventional tap bypass 120. As described above, conventional tap bypass 120 is used to provide premises downstream with service/signal when front side cover 102 is removed from tap assembly 100. Referring to FIG. 2(b), FIG. 2(b) shows of the opposite side “B” of a conventional tap bypass 120, outside of tap assembly enclosure 100. Conventional tap bypass 120 includes a first stinger connection member 122, and a second stinger connection member 124. A “stinger” as used herein is a “coax center conductor” which provides conductivity between the unshielded coax signal line and the tap assembly 100. Stinger connection members 122, 124 are also commonly referenced to as “seizure assemblies” in the art. First stinger connection member 122 is used to physically and communicatively couple a singer of upstream main signal line 104 thereto. Similar to first stinger connection member 122, second stinger connection member 124 is used to physically and communicatively couple a stinger of downstream main signal line 106 thereto. Conventional tap bypass 120 also has a center conductive member 126 to carry signal and AC power (current) between first and second stinger connection members 122, 124.

Referring to FIG. 2(c), FIG. 2(c) is an illustration of a close-up of a conventional stinger connection member 124 of a conventional tap bypass 120. Each stinger connection member 122, 124 comprises a stinger insert 130 and member housing 131. Referring to FIGS. 2(c)-2(d), a stinger 119, 115 of main signal line 104, 106 must be inserted in stinger insert 130. Stinger insert 130 is essentially a conductive cylinder hollowed to receive a stinger 119, 115. In order to insert a stinger 119, 115 of main signal line 104, 106 into stinger insert 130, the entire tap bypass must be disassembled into its three constituent parts: first stinger connection member 122, second stinger connection member 124, and center conductive member 126.

The above described disassembly is needed in order to slide each stinger insert 130 (see the direction of arrow 141 for second stinger connection member 124) onto their respective stinger 119, 115, as can be seen in FIGS. 2(c)-2(d). After each stinger connection member 122, 124, is slid onto their respective stingers 119, 115, center conductive member 126 must be affixed to the first and second stinger connection members 122, 124 via connection joint 132, on each side, by means of a small screw(s). Finally, the entire conventional tap bypass 120 must be mounted onto back side cover 118 of conventional tap assembly 100, with side “A” facing front side cover 102, at a number of mounting points 132. This above described disassembly/re-assembly process must occur as the tap assembly 100 is still affixed to the main signal lines 104, 106. This is a time consuming process because the tap bypass 120 and its mounting screws are fairly small in size. Further, tap assembly 100 is typically on a telephone pole many feet off the ground. Hence, upon installation or replacement of a conventional tap bypass 120, premises downstream are typically without service/signal for approximately 30 minutes to one (1) hour. Please note that stinger insert 130 typically can be rotated 90 degrees from position 140 to position 138 via pivot point 136 to accommodate main signal lines 104, 106 at horizontal input and output 108, 110, or vertical input and output 114, 116.

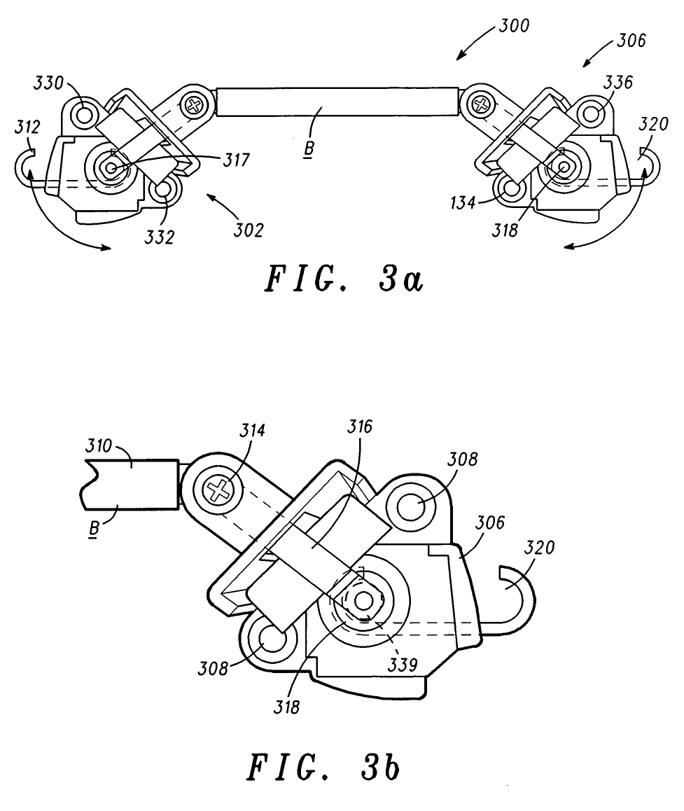

Referring to FIG. 3(a), in an accordance with an exemplary embodiment, the present invention provides an inventive tap bypass 300 which can be installed with minimal service/signal downtime for premises downstream, and method of manufacturing the same.

Inventive tap bypass 300 includes a first stinger connection member 302, and a second stinger connection member 306. First stinger connection member 302 is used to physically and communicatively coupled stinger 119 of upstream main signal line 104 to inventive first stinger insert 312. Similar to first stinger connection member 302, second stinger connection member 306 is used to physically and communicatively coupled stinger 115 of downstream main signal line 106 to inventive second stinger insert 320. Inventive tap bypass 300 also has a center conductive member 310 to carry signal and AC power (current) between first and second stinger inserts 312, 320 of first and second stinger connection members 302, 306, respectively.

Referring to FIG. 3(b), in accordance with an exemplary embodiment of the present invention, each stinger insert 312, 320 is fabricated as to have a notch therein to laterally receive a stinger 119, 115 in a parallel manner. Further, each inventive stinger insert 312, 320 can receive stinger 119, 115 from horizontal input and output 108, 110, or vertical input and output 114, 116, respectively, by pivoting stinger insert 312, 320 at pivot point 317, 318, respectively. Further, on the “B” side, housing of first and second stinger connection member 302, 306 is fabricated as to allow for the above described pivoting of each stinger insert 312, 320, with each notch being exposed for lateral/parallel installation of inventive tap bypass 300 into back side cover 118, as can be seen in FIGS. 3(a)-3(b).

Referring to FIGS. 3(a), 3(b), and 2(d), for installation, after stinger inserts 312, 320 are effortlessly pivoted in the correct origination of each stinger 119, 115 (based on which inputs 104, 114 and outputs 110, 116 main signal lines 104, 106 arrive), inventive tap bypass 300 can simply be placed over stingers 119, 115, with side “B” of inventive tap bypass 300 facing back side cover 118, for easy installation. Thereafter, inventive tap bypass 300 just needs to be mounted to the back side cover 118 by mounting points 330, 332, 334, 336. (Opposite side “A” of inventive tap bypass 300 may be fabricated similar to side “A” of conventional tap bypass 120.)

Thus, the present invention provides an inventive tap bypass which can be installed with minimal service/signal downtime for premises downstream, and method of manufacturing the same.

Although the invention has been described herein by reference to an exemplary embodiment thereof, it will be understood that such embodiment is susceptible of modification and variation without departing from the inventive concepts disclosed. All such modifications and variations, therefore, are intended to be encompassed within the spirit and scope of the appended claims.

We claim:

1. A tap bypass for maintaining signal conductivity between two signal lines when a front side cover of a tap assembly is removed, said tap bypass comprising:
a first stinger connection member, said first member comprising a first stinger insert, said first stinger insert comprising a notch for laterally receiving a first stinger of a first signal line; and
a second stinger connection member, said second member comprising a second stinger insert, said second stinger insert comprising a notch for laterally receiving a second stinger of a second signal line, said first member and said second member being communicatively coupled to allow signal to flow between said first signal line and said second signal line.

2. The tap bypass of claim 1 further comprising a center conductive member coupled to said first and second members, said center conductive member communicatively allow signal to flow between said first signal line and said second signal line.

3. The tap bypass of claim 1, wherein said notch of said first stinger insert is capable of pivoting to receive a first stinger which is horizontally displaced.

4. The tap bypass of claim 1, wherein said notch of said first stinger insert is capable of pivoting to receive a first stinger which is vertically displaced.

5. The tap bypass of claim 1, wherein said notch of said second stinger insert is capable of pivoting to receive a second stinger which is horizontally displaced.

6. The tap bypass of claim 1, wherein said notch of said second stinger insert is capable of pivoting to receive a second stinger which is vertically displaced.

7. The tap bypass of claim 1, wherein said notch of said first stinger insert is electronically conductive.

8. The tap bypass of claim 1, wherein said notch of said second stinger insert is electronically conductive.

9. The tap bypass of claim 1, wherein said center conductive member is electronically conductive.

10. A method of manufacturing a tap bypass, said method comprising:
fabricating a first stinger connection member comprising a first stinger insert, said first stinger insert having a notch for laterally receiving a first stinger of a first signal line, and a first housing;
fabricating a second stinger connection member comprising a second stinger insert, said second stinger insert having a notch for laterally receiving a second stinger of a second signal line, and a second housing; said first member and said second member being communicatively coupled to allow signal to flow between said first signal line and said second signal line.

11. The method of claim 10 further comprising the step of fabricating a center conductive member coupled to said first and second stinger inserts, said center conductive member communicatively allow signal to flow between said first signal line and said second signal line.

12. The method of claim 10 further comprising fabricating said first notch of said first stinger insert so as to allow said first stinger insert to articulate to a horizontal or vertical position.

13. The method of claim 10 further comprising fabricating said second notch of said second stinger insert so as to allow said second stinger insert to articulate to a horizontal or vertical position.

14. The method of claim 12, further comprising fabricating said first housing of said first member to allow for articulation of said first stinger insert.

15. The method of claim 13, further comprising fabricating said second housing of said second member to allow for articulation of said second stinger insert.
